(19) United States
(12) Patent Application Publication
(10) Pub. No.: US 2026/0339827 A1
(43) Pub. Date: Oct. 29, 2026

(54) Persona-Based Application Testing using Artificial Intelligence

(71) Applicant: International Business Machines Corporation, Armonk, NY (US)

(72) Inventors: Iain Furneaux, Witley (GB); Simon Greig, Guildford (GB)

(21) Appl. No.: 19/192,646

(22) Filed: Apr. 29, 2025

(51) Int. Cl. G06F 11/3668; G06N 20/00

(52) U.S. Cl. CPC G06F 11/3688; G06N 20/00

(57) ABSTRACT

Performing persona-based application testing is provided. A pattern of interactions with an application by a selected persona is determined using a set of AI models based on demographic data corresponding to the selected persona generated by the set of AI models. A persona-based test of the application is performed by the set of AI models using the pattern of interactions with the application by the selected persona determined by the set of AI models. A result of the persona-based test of the application is output to a client device user.

### BACKGROUND

The disclosure relates generally to application testing and more specifically to performing application testing.

Application testing is needed for software development to maintain standards of an application and the application's ability to provide the functionality for which the application is being developed. As much as a user interface is checked to ensure that the user interface has been implemented correctly to meet the specification, functional testing assists in the identification of defects or flaws in the application that may deviate from the specification. Thus, no matter if the application was produced in the field of mobile, web, or complex enterprise software, testing assures that the application results in a stable and effective product.

Application testing is a broad process whose primary goal is assessing and proving the reliability of the application. This application testing process entails using the application in a well-planned and organized manner to let a program developer or tester discover whether some problems exist or whether there is a lack of conformity with the requirements and their functioning in different circumstances. In other words, application testing involves assessing an application's functionality, performance, security, usability, and the like to ensure the application meets the intended requirements.

### SUMMARY

According to one illustrative embodiment, a computer-implemented method is provided. A computer, using a set of Artificial Intelligence (AI) models, determines a pattern of interactions with an application by a selected persona based on demographic data corresponding to the selected persona generated by the set of AI models. The computer, using the set of AI models, performs a persona-based test of the application using the pattern of interactions with the application by the selected persona determined by the set of AI models. The computer outputs a result of the persona-based test of the application to a client device user. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of a persona-based whole life application testing process in accordance with an illustrative embodiment;

FIG. 3 is a diagram illustrating an example of an AI model training process in accordance with an illustrative embodiment;

FIG. 4 is a diagram illustrating an example of a persona-based application testing process in accordance with an illustrative embodiment; and

FIGS. 5A-5B are a flowchart illustrating a high-level process for persona-based application testing in accordance with an illustrative embodiment.

### DETAILED DESCRIPTION

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CPP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

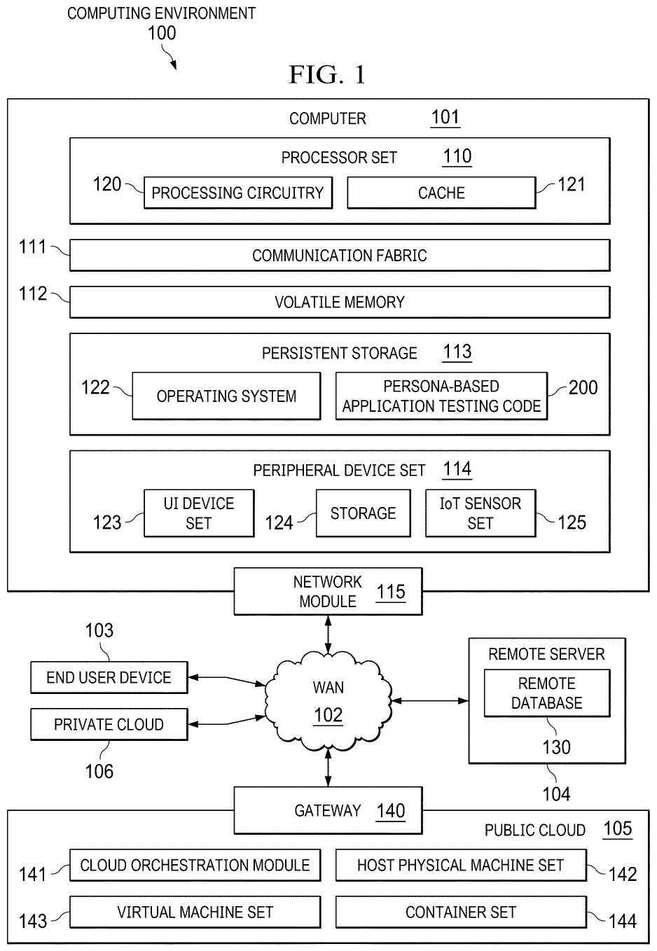

With reference now to the figures, and in particular, with reference to FIG. 1, a diagram of a data processing environment is provided in which illustrative embodiments may be implemented. It should be appreciated that FIG. 1 is only meant as an example and is not intended to assert or imply any limitation with regard to the environments in which different embodiments may be implemented. Many modifications to the depicted environment may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as persona-based application testing code 200. For example, persona-based application testing code 200 enables comprehensive testing of applications from a user's perspective. Persona-based application testing code 200 generates a full persona-based data model for Artificial Intelligence (AI) model building and training. In addition, persona-based application testing code 200 also generates a physical application interaction-based model for each respective persona for the AI model building and training. Further, persona-based application testing code 200 generates linkages between persona-based data models and application interaction-based models. Furthermore, persona-based application testing code 200 provides an ability to age a persona over time for whole life application testing. Moreover, persona-based application testing code 200 can link different personas together, along with events and objects, such as, for example, linking spouses with birth of a first descendant, birth of a second descendant, plus purchasing a house, opening a bank account, owning a vehicle, and the like for application testing.

In addition to persona-based application testing code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and persona-based application testing code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in persona-based application testing code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source portable operating system interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices.

Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers.

IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a program developer who utilizes the persona-based application testing services provided by computer 101), and may take any of the forms discussed above in connection with computer 101. EUD 103 typically receives helpful and useful data from the operations of computer 101. For example, in a hypothetical case where computer 101 is designed to provide a result of the persona-based application testing to the end user, this result would typically be communicated from network module 115 of computer 101 through WAN 102 to EUD 103. In this way, EUD 103 can display, or otherwise present, the result of the persona-based application testing to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a result of persona-based application testing based on collected demographic and application interaction data, then this collected demographic and application interaction data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A, one of item B, and ten of item C, or four of item B and seven of item C, or other suitable combinations.

Application testing needs to reasonably replicate real-world scenarios and use cases. For example, test cases for application testing should mimic interactions by all intended personas. In addition, the test cases should mimic realistic data combinations. Further, test cases may also mimic unrealistic data combinations to ensure error trapping.

User acceptance testing is a phase in application testing where the application is tested in a real-world scenario by end-users to ensure the application meets expected requirements and functions. Unlike other forms of application testing, user acceptance testing focuses on validating the application's user-friendliness, functionality, and performance from the end-user's perspective. However, user acceptance testing is generally carried out by a small group of potential end-users, often for the same industry or business area. Further, user acceptance testing has inherent bias. For example, the creator of the test cases will include bias based on a number of factors such as, for example, age, demographic, technical ability, subject matter understanding, and the like. Furthermore, some demographic and user interaction variations will be missed by using a small group of end-users to conduct user acceptance testing. Moreover, user acceptance testing is also generally carried out at the end of the development cycle when the application is fully formed. This means that any needed changes will take longer and will be more expensive than should the changes have been discovered earlier. The ability of illustrative embodiments to realistically test earlier from a user's perspective may save time and, therefore, money.

In contrast, illustrative embodiments utilize AI for persona-based application testing. As used herein, persona may include at least one of a person, an object, and an event. A person has attributes such as name, date of birth, address, and the like. An object (e.g., a vehicle) has attributes such as function, size, weight, and the like. An event is a circumstance that has varying attributes such as a surge in electrical power demand due to high temperatures causing power failure to local residences, sharp decline in stock market prices causing financial losses to stockholders, and the like. Application testing scenarios for a persona may include, for example: an application that collects details regarding a person and performs a set of actions based the collected details; an application that configures, builds, sells, or controls an object for a persona (e.g., a flight control application that monitors a number of objects (e.g., aircraft, each having an aircraft type, flight plan, and the like); an application that manages an event interactively or post event for a persona (e.g., an electrical grid power distribution application that may simulate different public events having different associated power expectations); and the like.

Illustrative embodiments build and train a set of AI models based on end-user personas and real-world end-user persona interactions with applications. An end-user persona may correspond to a person, an AI agent that performs tasks on behalf of a person, or the like. The set of AI models may be, for example, one or more specialized Large Language Models. For example, illustrative embodiments record end-user interactions with an application that include hesitations such as entry delays, entry corrections, time to complete a process or task in application, and the like and label or tag the recorded end-user interactions with certain end-user persona demographic information such as age, education, geographic location, income, marital status, and the like. Illustrative embodiments input a plurality of different end-user personas within a demographic group into the set of AI models. It should be noted that different demographic groups may be adjoining or overlapping. Illustrative embodiments also input data for similar persona demographic groups into the set of AI models.

Illustrative embodiments collect anonymized demographic data, as well as other life data such as number of siblings, number of descendants, number of residences, number of vehicles, and the like. Illustrative embodiments also collect end-user persona life event data such as age at purchase of first house, age at birth of first descendant, age at marriage, salary at various ages, debt at various ages, and the like. Illustrative embodiments correlate and link these events and objects with the end-user persona.

However, it should be noted that age of the persona is just one factor that illustrative embodiments take into account. For example, assume illustrative embodiments are testing a travel insurance application and illustrative embodiments have multiple identical personas that are varied only by country of origin (e.g., in one location in the world a 27-year-old may typically be married with children, whereas in another location the 27-year-old may typically be single). This would have an effect on the persona in its entirety and consequently may change the quote and coverage of the travel insurance for each persona in each different geographic location. In addition, when illustrative embodiments are iterating through a persona and varying one or more attributes, assuming the persona represents the same person that is just getting older, an application history can contribute to the persona. For example, if a 19-year-old persona was refused a loan and the 19-year-old persona checked its credit score which was poor, then the 19-year-old persona may adjust its behavior so that when the loan application is rerun as a 25-year-old persona, the 25-year-old persona is more likely to secure the loan. In other words, illustrative embodiments mimic a typical human in an automated way as closely as possible through changing life events and consequently alter persona behavior using the set of AI models and then applying that to the application being tested.

Illustrative embodiments use the collected data to train and enhance the set of AI models. The set of AI models may include, for example, a persona-based AI model and an application interaction-based AI model. However, alternative illustrative embodiments may combine the persona-based AI model and the application interaction-based AI model into one AI model.

Illustrative embodiments utilize the set of AI models to generate test scripts or scenarios for any given persona demographic or socio-economic group either as an operator persona or as a subject persona. An operator persona is a person who is directly interacting with an application without assistance from others. A subject persona is a person who has another person (e.g., application user such as a customer service representative) interact with the application on behalf of that person. Illustrative embodiments utilize the set of AI models to generate realistic data corresponding to a persona based on the persona selected by an entity (e.g., program developer) requesting testing of the application.

One example of generated realistic data for a selected persona is a 63-year-old person who lives in a certain geographic region of a country, is married, is retired, is a homeowner with no mortgage, has a one year old vehicle lease agreement, owns a vintage car, has two adult descendants, has no credit card debt, has $100,000 in a savings account, and has a mobile phone. Another example of generated realistic data for a selected persona is a 24-year-old person who lives in a particular city, is single, has a low paying semi-seasonal job, lives in parents' house, owns an early model vehicle, has no dependents, recently received a post graduate degree, has $17,000 in student loan and credit card debt, and has a mobile phone.

Both examples of personas above present a different use case to an application under test, each persona interacting with that same application in a different way. For example, the 24-year-old is more likely to be digitally astute and, therefore, may be able to interact with the application in a much faster and more positive manner than the 63-year-old. As a result, the set of AI models adjust or alter the interactions with the application under test to match the data generated for that particular persona selected. When the data corresponds to some other form of persona, the demographics may be independent to the data. For example, when an operator persona, such as customer service representative, an AI agent, or the like, is inputting data into an application for a subject persona, the application interaction model of the operator persona will not match the demographic model of the subject persona.

The set of AI models can generate fragments of realistic data corresponding to a persona for application testing. However, the set of AI models can generate a large volume of data for a persona if needed. It should be noted that no existing application testing solution uses persona-based data generation for application testing. Further, no existing application testing solution uses different types of personas to interact with an application with different application interaction patterns or styles.

Thus, illustrative embodiments provide one or more technical solutions that overcome a technical problem with an inability of existing application testing solutions to perform persona-based application testing using different types of personas that will interact with applications with different application interaction patterns. As a result, these one or more technical solutions provide a technical effect and practical application in the field of application testing.

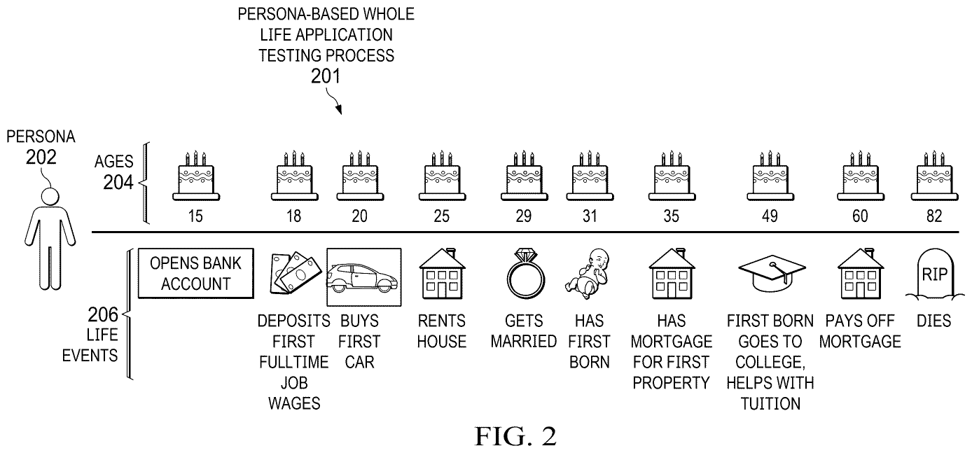

With reference now to FIG. 2, a diagram illustrating an example of a persona-based whole life application testing process is depicted in accordance with an illustrative embodiment. Persona-based whole life application testing process 201 may be implemented in a computer, such as computer 101 in FIG. 1. For example, persona-based whole life application testing process 201 may be implemented by persona-based application testing code 200 in FIG. 1.

In this example, persona-based whole life application testing process 201 includes persona 202, ages 204, and life events 206. However, it should be noted that persona-based whole life application testing process 201 is intended as one specific example only and not as a limitation on illustrative embodiments. For example, persona-based whole life application testing process 201 may include any number of personas at any age having any number and types of life events.

In this example, persona-based whole life application testing process 201 achieves persona-based whole life testing of a banking application using persona 202. For example, persona-based whole life application testing process 201 regenerates persona 202 at different ages 204 corresponding to various life events 206 for testing the banking application. Using a set of AI models, persona-based whole life application testing process 201 generates realistic data for the various life events 206 corresponding to persona 202 at the different ages 204 and inputs the generated realistic data into the banking application during testing. Each of life events 206 changes the data and persona-based whole life application testing process 201 using the set of AI models regenerates persona 202 to match each particular life event of life events 206, as well as modifies the behavior of persona 202 when interacting with the banking application to match each different age of the person. Furthermore, persona-based whole life application testing process 201 can generate a group of personas to test the banking application from many perspectives, as well as ageing the group of personas.

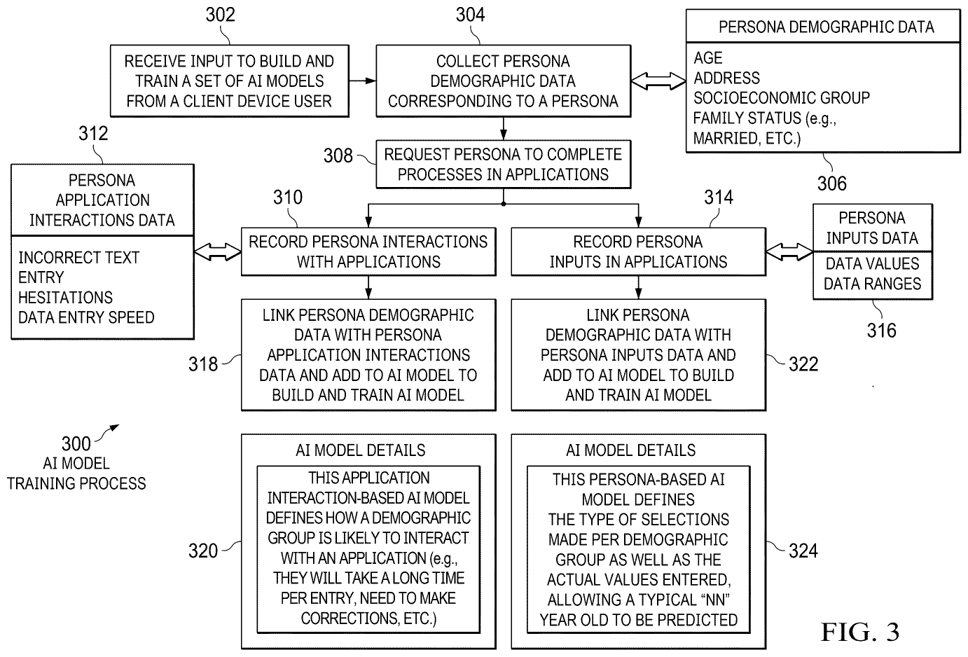

With reference now to FIG. 3, a diagram illustrating an example of an AI model training process is depicted in accordance with an illustrative embodiment. AI model training process 300 may be implemented in a computer, such as computer 101 in FIG. 1. For example, AI model training process 300 may be implemented by persona-based application testing code 200 in FIG. 1.

In this example, at 302, the computer receives an input to build and train a set of AI models from a client device user. The user may be, for example, a program developer, system administrator, or the like. The client device may be, for example, EUD 103 in FIG. 1. The set of AI models may include, for example, a persona-based AI model and an application interaction-based AI model.

At 304, the computer collects persona demographic data 306 corresponding to a persona. Persona demographic data 306 include, for example, age, address, socioeconomic group, family status, and the like corresponding to the persona. At 308, the computer requests the persona to complete processes in applications.

At 310, the computer records persona interactions with the applications as persona application interactions data 312. Persona application interactions data 312 include, for example, incorrect text entries, hesitations, data entry speed, and the like. Also, at 314, the computer records persona inputs in the applications as persona inputs data 316. Persona inputs data 316 include, for example, data values, data ranges, and the like.

At 318, the computer links persona demographic data 306 with persona application interactions data 312 and adds persona demographic data 306 and persona application interactions data 312 to an application interaction-based AI model to build and train the application interaction-based AI model. AI model details 320 indicate that this application interaction-based AI model defines how a demographic group is likely to interact with an application (e.g., they will take a long time per entry, need to make corrections, et cetera).

In addition, at 322, the computer links persona demographic data 306 with persona inputs data 316 and adds persona demographic data 306 and persona inputs data 316 to a persona-based AI model to build and train the persona-based AI model. AI model details 324 indicate this persona-based AI model defines the type of selections made per demographic group as well as the actual values entered, allowing a typical “NN”-year-old to be predicted.

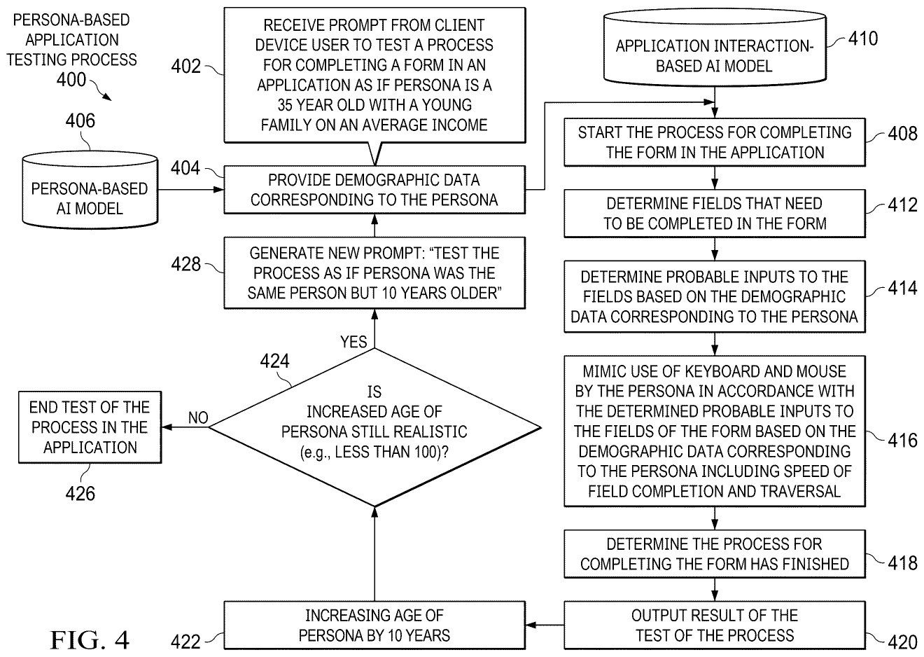

With reference now to FIG. 4, a diagram illustrating an example of a persona-based application testing process is depicted in accordance with an illustrative embodiment. Persona-based application testing process 400 may be implemented in a computer, such as computer 101 in FIG. 1. For example, persona-based application testing process 400 may be implemented by persona-based application testing code 200 in FIG. 1.

In this example, at 402, the computer receives a prompt from a client device user to test a process for completing a form in an application as if the persona is a 35-year-old with a young family on an average income. At 404, the computer uses persona-based AI model 406 to provide demographic data corresponding to the persona.

In addition, at 408, the computer uses application interaction-based AI model 410 to start the process for completing the form in the application. At 412, the computer using application interaction-based AI model 410 determines fields that need to be completed in the form. Further, at 414, the computer using application interaction-based AI model 410 determines probable inputs to the fields based on the demographic data corresponding to the persona provided by persona-based AI model 406.

At 416, the computer using application interaction-based AI model 410 mimics use of the keyboard and mouse by the persona in accordance with the determined probable inputs to the fields of the form based on the demographic data corresponding to the persona including speed of field completion and traversal. At 418, the computer using application interaction-based AI model 410 determines that the process for completing the form has finished. At 420, the computer using application interaction-based AI model 410 outputs a result of the test of the process to the client device user.

Then, at 422, the computer increases an age of the persona by 10 years. Afterward, at 424, the computer determines whether the increased age of the persona is still realistic (e.g., less than 100 years old). If the computer determines that the increased age of the persona is not realistic, then, at 426, the computer ends the test of the process in the application. If the computer determines that the increased age of the persona is still realistic, then, at 428, the computer generates a new prompt to test the process as if the persona were the same person but 10 years older. Thereafter, the computer using persona-based AI model 406 provides new demographic data corresponding to the persona for 10 years later continuing persona-based application testing process 400.

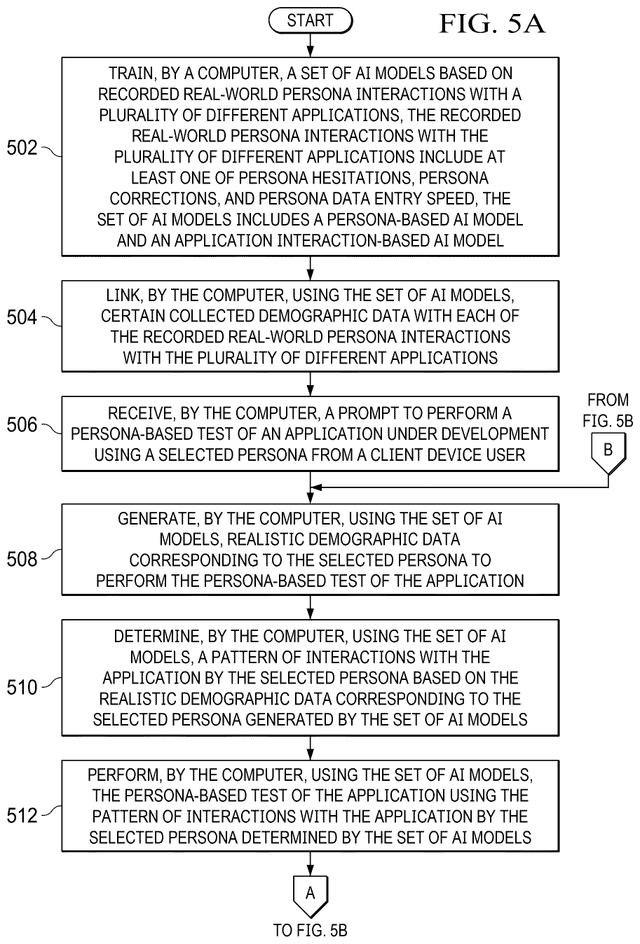

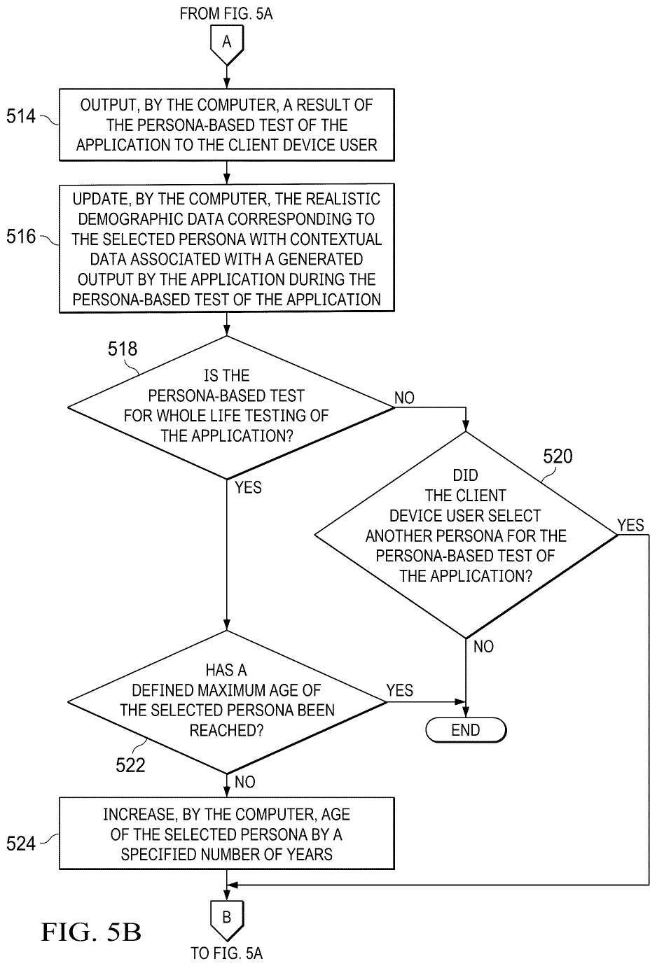

With reference now to FIGS. 5A-5B, a flowchart illustrating a high-level process for persona-based application testing is shown in accordance with an illustrative embodiment. The process shown in FIGS. 5A-5B may be implemented in a computer, such as, for example, computer 101 in FIG. 1. For example, the process shown in FIGS. 5A-5B may be implemented by persona-based application testing code 200 in FIG. 1.

The process begins when the computer trains a set of AI models based on recorded real-world persona interactions with a plurality of different applications (step 502). The recorded real-world persona interactions with the plurality of different applications include at least one of persona hesitations, persona corrections, and persona data entry speed. The set of AI models includes a persona-based AI model and an application-interaction-based AI model. The computer, using the set of AI models, links certain collected demographic data with each of the recorded real-world persona interactions with the plurality of different applications (step 504).

Subsequently, the computer receives a prompt to perform a persona-based test of an application under development using a selected persona from a client device user (step 506). The computer, using the set of AI models, generates realistic demographic data corresponding to the selected persona to perform the persona-based test of the application in response to receiving the prompt (step 508).

The computer, using the set of AI models, determines a pattern of interactions with the application by the selected persona based on the realistic demographic data corresponding to the selected persona generated by the set of AI models (step 510). The computer, using the set of AI models, performs the persona-based test of the application using the pattern of interactions with the application by the selected persona determined by the set of AI models (step 512). The computer outputs a result of the persona-based test of the application to the client device user (step 514). The computer updates the realistic demographic data corresponding to the selected persona with contextual data associated with a generated output by the application during the persona-based test of the application (step 516). For example, the selected persona submits an order in the application being tested. The order submission may reply with an order reference number. Subsequently, in this example test case, the selected persona is filling in a “where is my order?” form and one of the fields asks for the order reference number. The set of AI models is able to fill in the form with data from the generated realistic demographic data (e.g., name, email, and the like), but also knows that it recently received the order reference number so that can also be filled in the form.

The computer makes a determination as to whether the persona-based test is for whole life testing of the application (step 518). If the computer determines that the persona-based test is not for whole life testing of the application, no output of step 518, then the computer makes a determination as to whether the client device user selected another persona for the persona-based test of the application (step 520). If the computer determines that the client device user did not select another persona for the persona-based test of the application, no output of step 520, then the process terminates thereafter. If the computer determines that the client device user did select another persona for the persona-based test of the application, yes output of step 520, then the process returns to step 508 where the computer, using the set of AI models, generates different realistic demographic data corresponding to the other persona. Returning to step 518, if the computer determines that the persona-based test is for whole life testing of the application, yes output of step 518, then the computer makes a determination as to whether a defined maximum age of the selected persona has been reached (step 522).

If the computer determines that the defined maximum age of the selected persona has been reached, yes output of step 522, then the process terminates thereafter. If the computer determines that the defined maximum age of the selected persona has not been reached, no output of step 522, then the computer increases age of the selected persona by a specified number of years (step 524). The specified number of years may be, for example, one, two, three, five, ten, fifteen, twenty, or any other number of years. Thereafter, the process returns to step 508 where the computer, using the set of AI models, generates new realistic demographic data corresponding to the selected persona at the age increased by the specified number of years.

Thus, illustrative embodiments of the present disclosure provide a computer-implemented method, computer system, and computer program product for performing persona-based application testing using AI. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining, by a computer, using a set of Artificial Intelligence (AI) models, a pattern of interactions with an application by a selected persona based on demographic data corresponding to the selected persona generated by the set of AI models;
performing, by the computer, using the set of AI models, a persona-based test of the application using the pattern of interactions with the application by the selected persona determined by the set of AI models; and
outputting, by the computer, a result of the persona-based test of the application to a client device user.

2. The computer-implemented method of claim 1, further comprising:
receiving, by the computer, a prompt to perform the persona-based test of the application using the selected persona from the client device user; and
generating, by the computer, using the set of AI models, the demographic data corresponding to the selected persona to perform the persona-based test of the application in response to receiving the prompt.

3. The computer-implemented method of claim 1, further comprising:
determining, by the computer, whether the persona-based test is for whole life testing of the application;
responsive to the computer determining that the persona-based test is not for whole life testing of the application, determining, by the computer, whether the client device user selected another persona for the persona-based test of the application; and
responsive to the computer determining that the client device user did select another persona for the persona-based test of the application, generating, by the computer, using the set of AI models, different realistic demographic data corresponding to the another persona.

4. The computer-implemented method of claim 3, further comprising:
responsive to the computer determining that the persona-based test is for whole life testing of the application, determining, by the computer, whether a defined maximum age of the selected persona has been reached;
responsive to the computer determining that the defined maximum age of the selected persona has not been reached, increasing, by the computer, age of the selected persona by a specified number of years; and
generating, by the computer, using the set of AI models, new realistic demographic data corresponding to the selected persona at the age increased by the specified number of years.

5. The computer-implemented method of claim 1, further comprising:
training, by the computer, the set of AI models based on recorded real-world persona interactions with a plurality of different applications; and
linking, by the computer, using the set of AI models, certain collected demographic data with each of the recorded real-world persona interactions with the plurality of different applications.

6. The computer-implemented method of claim 5, wherein the recorded real-world persona interactions with the plurality of different applications include at least one of persona hesitations, persona corrections, and persona data entry speed.

7. The computer-implemented method of claim 5, wherein the set of AI models includes a persona-based AI model and an application-interaction-based AI model.

8. A computer system comprising:
a processor set;
one or more computer-readable storage media; and
program instructions stored on the one or more computer-readable storage media to cause the processor set to perform operations comprising:
determining, using a set of Artificial Intelligence (AI) models, a pattern of interactions with an application by a selected persona based on demographic data corresponding to the selected persona generated by the set of AI models;
performing, using the set of AI models, a persona-based test of the application using the pattern of interactions with the application by the selected persona determined by the set of AI models; and
outputting a result of the persona-based test of the application to a client device user.

9. The computer system of claim 8, wherein the operations further comprise:
receiving a prompt to perform the persona-based test of the application using the selected persona from the client device user; and
generating, using the set of AI models, the demographic data corresponding to the selected persona to perform the persona-based test of the application in response to receiving the prompt.

10. The computer system of claim 8, wherein the operations further comprise:
determining whether the persona-based test is for whole life testing of the application;
responsive to determining that the persona-based test is not for whole life testing of the application, determining whether the client device user selected another persona for the persona-based test of the application; and
responsive to determining that the client device user did select another persona for the persona-based test of the application, generating, using the set of AI models, different realistic demographic data corresponding to the another persona.

11. The computer system of claim 10, wherein the operations further comprise:
responsive to determining that the persona-based test is for whole life testing of the application, determining whether a defined maximum age of the selected persona has been reached;
responsive to determining that the defined maximum age of the selected persona has not been reached, increasing age of the selected persona by a specified number of years; and
generating, using the set of AI models, new realistic demographic data corresponding to the selected persona at the age increased by the specified number of years.

12. The computer system of claim 8, wherein the operations further comprise:
training the set of AI models based on recorded real-world persona interactions with a plurality of different applications; and
linking, using the set of AI models, certain collected demographic data with each of the recorded real-world persona interactions with the plurality of different applications.

13. The computer system of claim 12, wherein the recorded real-world persona interactions with the plurality of different applications include at least one of persona hesitations, persona corrections, and persona data entry speed.

14. A computer program product comprising:
one or more computer-readable storage media; and
program instructions stored on the one or more computer-readable storage media to perform operations comprising:
determining, by a computer, using a set of Artificial Intelligence (AI) models, a pattern of interactions with an application by a selected persona based on demographic data corresponding to the selected persona generated by the set of AI models;
performing, by the computer, using the set of AI models, a persona-based test of the application using the pattern of interactions with the application by the selected persona determined by the set of AI models; and
outputting, by the computer, a result of the persona-based test of the application to a client device user.

15. The computer program product of claim 14, wherein the operations further comprise:
receiving, by the computer, a prompt to perform the persona-based test of the application using the selected persona from the client device user; and
generating, by the computer, using the set of AI models, the demographic data corresponding to the selected persona to perform the persona-based test of the application in response to receiving the prompt.

16. The computer program product of claim 14, wherein the operations further comprise:
determining, by the computer, whether the persona-based test is for whole life testing of the application;
responsive to the computer determining that the persona-based test is not for whole life testing of the application, determining, by the computer, whether the client device user selected another persona for the persona-based test of the application; and
responsive to the computer determining that the client device user did select another persona for the persona-based test of the application, generating, by the computer, using the set of AI models, different realistic demographic data corresponding to the another persona.

17. The computer program product of claim 16, wherein the operations further comprise:
responsive to the computer determining that the persona-based test is for whole life testing of the application, determining, by the computer, whether a defined maximum age of the selected persona has been reached;
responsive to the computer determining that the defined maximum age of the selected persona has not been reached, increasing, by the computer, age of the selected persona by a specified number of years; and
generating, by the computer, using the set of AI models, new realistic demographic data corresponding to the selected persona at the age increased by the specified number of years.

18. The computer program product of claim 14, wherein the operations further comprise:
training, by the computer, the set of AI models based on recorded real-world persona interactions with a plurality of different applications; and
linking, by the computer, using the set of AI models, certain collected demographic data with each of the recorded real-world persona interactions with the plurality of different applications.

19. The computer program product of claim 18, wherein the recorded real-world persona interactions with the plurality of different applications include at least one of persona hesitations, persona corrections, and persona data entry speed.

20. The computer program product of claim 18, wherein the set of AI models includes a persona-based AI model and an application-interaction-based AI model.
